(19) United States
(12) Patent Application Publication
(10) Pub. No.: US 2005/0156603 A1
(43) Pub. Date: Jul. 21, 2005

(54) Method of testing a battery pack by purposeful charge/discharge operations

(76) Inventors: Hsin-An Lin, Pei-Tou Chen (TW); Kuo-Hsien Tsai, Tali City (TW)

Correspondence Address: BINGHAM, MCCUTCHEN LLP, THREE EMBARCADERO CENTER, 18 FLOOR, SAN FRANCISCO, CA, 94111-4067, US

(21) Appl. No.: 11/065,590

(22) Filed: Feb. 25, 2005

Related U.S. Application Data
(63) Continuation-in-part of application No. 10/404,555, filed on Apr. 2, 2003.

(51) Int. Cl. H02J 7/00

(52) U.S. Cl. 324/433

(57) ABSTRACT

A method of testing a battery pack, wherein a load is connected to a charger and the battery pack, and receives power supply from either the external charger or the battery pack. When the external power line is normally supplied to the load through the charger, the battery pack is purposely enabled to start its discharge and to supply power to the load. When the output voltage of the battery pack drops below a threshold level or the discharging time exceeds a preset limit, the charger re-supplies its output voltage to the load and to charge the battery pack. By the purposeful charge/discharge operations, characteristic data of the battery pack are collected and recorded for estimation of the battery pack capacity and the remaining service life.

### CROSS REFERENCE TO RELATED APPLICATION

The application is a continuation in part of U.S. patent application Ser. No. 10/404,555 filed Apr. 2, 2003.

### BACKGROUND OF THE INVENTION

1. Field of the Invention

The present invention relates to a method of testing a secondary battery pack, in particular to a method which enforces the secondary battery pack to have charge/discharge operations even when an external power is available, so that characteristic data of the secondary battery can be collected and recorded for estimation of the battery pack capacity and the remaining service life.

2. Description of Related Arts

Uninterrupted power supply (UPS) is widely employed in computers, communication systems and laboratories for protecting instruments and equipment from sudden power failures. The main component in a UPS is the battery pack. When the line power (external power) is normal, the battery pack is placed on a standby situation, but when the line power is interrupted, the battery pack should be able to supply power to the load. Since the interruption of the line power does not occur so often, the battery pack is usually kept in a floating charge status most of the time.

Because the battery pack is connected to a rectifier of a charger in parallel, energy stored in the battery pack is kept in a saturation condition by the continuous floating charge. However, the battery pack is rarely used or put through a discharge test in the normal condition. For a lead acid battery pack, it is possible to measure the specific gravity of the solution in the battery pack to estimate the battery capacity, but for hermetically sealed batteries, it will be difficult to determine the battery capacity merely by observing the appearance of the battery pack. Therefore, maintenance personnel without any test data cannot tell whether the battery capacity of a standby battery pack has significantly changed or deteriorated, as the battery capacity will decrease when internal battery cells deteriorate or the operating temperature goes up too high.

In prior art, a multi-channel voltage detection circuit is used to monitor the characteristics of the battery pack. The multi-channel voltage detection circuit is simultaneously connected to terminals of all battery cells of the battery pack, and then the input power is purposely interrupted to enforce the battery cells to start the discharging operation. After a predetermined period of the discharging, the input power is reconnected to the battery, and the discharging voltage data from all connected battery cells are recorded and saved in a file for creating a data file for reference. However, since the foregoing battery test method has to be conducted in a power off condition, considerable risk is involved.

In another prior art, a main controller is employed for monitoring and recording the battery characteristics. The main controller is connected to multiple battery packs through multiple switching devices. The main controller sequentially scans the battery packs to record their output currents, operating temperatures, and terminal voltages for compiling the characteristic data of the battery packs. Even when the line power is interrupted, the system is still capable of recording the characteristic data from a discharging battery pack, but the accuracy in the estimation of capacity may be affected due to the relatively short recording interval assigned for each battery pack.

The U.S. Pat. No. 5,606,242, entitled “Smart battery algorithm for reporting battery parameters to an external device” discloses a load 16 being powered via a system management bus 14 by a smart battery 10, or a system power supply 18 connected to a smart charger 22. The system power supply 18 may supply or draw power to/form the smart battery 10 over a power plane 12, depending upon the state of charge in the smart battery 10 and depending upon the present of absence of power at an AC source 20. Although the system power supply 18 can based on the detected status of the smart battery 10 to supply or draw power to/from the battery 10, the smart battery 10 still does not have intentional charge/discharge operations so that it is unable to ensure whether the battery 10 is normal.

In another U.S. Pat. No. 5,889,465, as long as a charger 20 supplies a power in excess of the battery DC voltage, batteries 80 are maintained in a charged state. If there is a disruption in the output from the charger 20, these batteries 80 begin to supply power to the load. However, the circuit still does not disclose a testing method for the batteries to ensure these batteries can normally supply power to the load while the power of the charger 20 is interrupted.

### SUMMARY OF THE INVENTION

The main objective of the present invention is to provide a method that enables a battery pack to discharge/charge purposely even when an external power is normal and available, so as to facilitate the recording of the characteristic data for accurate estimation of the battery pack capacity and the remaining service life.

To achieve the objective, the method uses a battery pack coupled to a load, the load being further connected to a charger that couples to an external power line, wherein the method comprising the acts of:
measuring a total voltage of all battery cells in the battery pack;
purposely decreasing an output voltage of the charger to a level below the total voltage of the battery pack by a control command, but still within an acceptable range for the load;
discharging of the battery pack and supplying its output voltage to the load instead of from the charger;
determining whether a charger resumption condition is met, wherein if the charger resumption condition is met, the output voltage of the charger is raised to re-supply to the load and to charge the battery pack, wherein the discharge of the battery pack is accordingly stopped.

The features and structure of the present invention will be more clearly understood when taken in conjunction with the accompanying drawings.

### BRIEF DESCRIPTION OF THE DRAWINGS

FIG. 1 shows the system architecture in accordance with the present invention; and

FIG. 2 is a flow chart revealing the steps for alternating power supply to the load.

FIG. 3 shows different waveforms including the output voltage of the battery pack, the output current of a charger, the output current of the battery pack and the input current of the load in accordance with the present invention.

### DETAILED DESCRIPTION OF THE PREFERRED EMBODIMENT

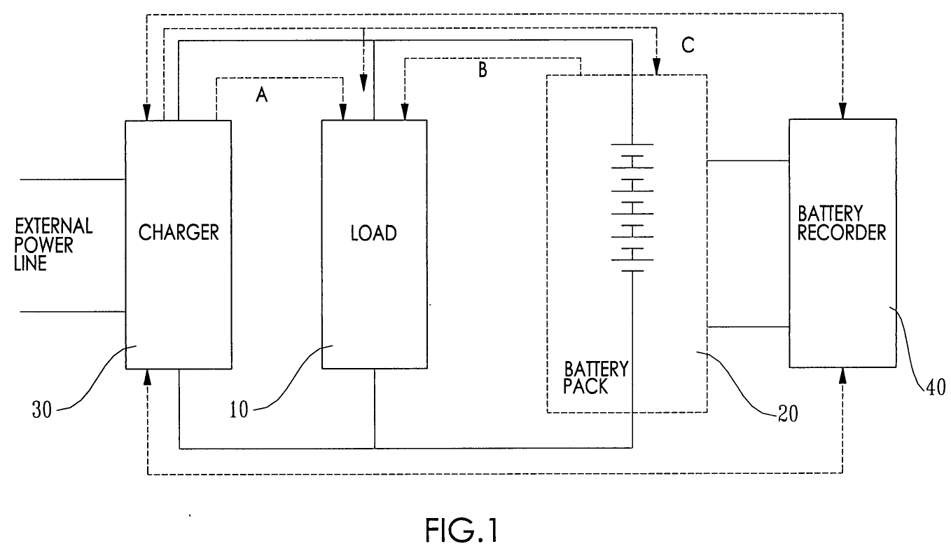

With reference to FIG. 1, a system architecture in accordance with the present invention shows a load (10) connected to a battery pack (20), and also connected to an external power line through a charger (30) in parallel. Under the normal power condition, the load (10) obtains the operating power from the external power line through the charger (30) as indicated by path A, and the battery pack (20) connected to the charger (30) is placed in a floating charge mode (standby mode) and remains at a floating charge potential.

The battery pack (20) can be coupled with a recorder (40) for recording the battery discharging data. The charger (30) in accordance with the preferred embodiment can be implemented by an uninterrupted power supply (UPS). It is noted that the charger (30) can based on the status of the battery pack (20) to charge the battery pack (20), and the output voltage potential of the charger (30) is able to be purposely controlled at a desired level.

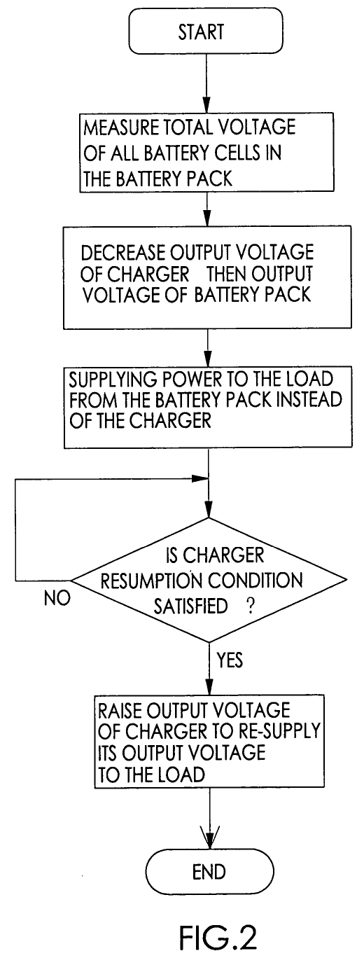

Based on the foregoing architecture, the method in accordance with the present invention performs a power bus arbitration model that comprises, at least, the steps of (as shown in FIG. 2):
measuring a total voltage of all battery cells in the battery pack (20);
purposely decreasing an output voltage of the charger (30) to a level below the total voltage of the battery pack (20), but still within an acceptable range for the load (10);
discharging of the battery pack (20) and supplying its output voltage to the load (10) instead of from the charger (30);
determining whether a charger resumption condition is met, wherein if the charger resumption condition is met, the output voltage of the charger (30) is raised to re-supply to the load (10) and to charge the battery pack (20), wherein the discharge of the battery pack (20) is accordingly stopped.

The above mentioned logical steps will be explained in more detail for further understanding of the operation in depth. In the following example, the battery pack (20) is composed of 58 cells.

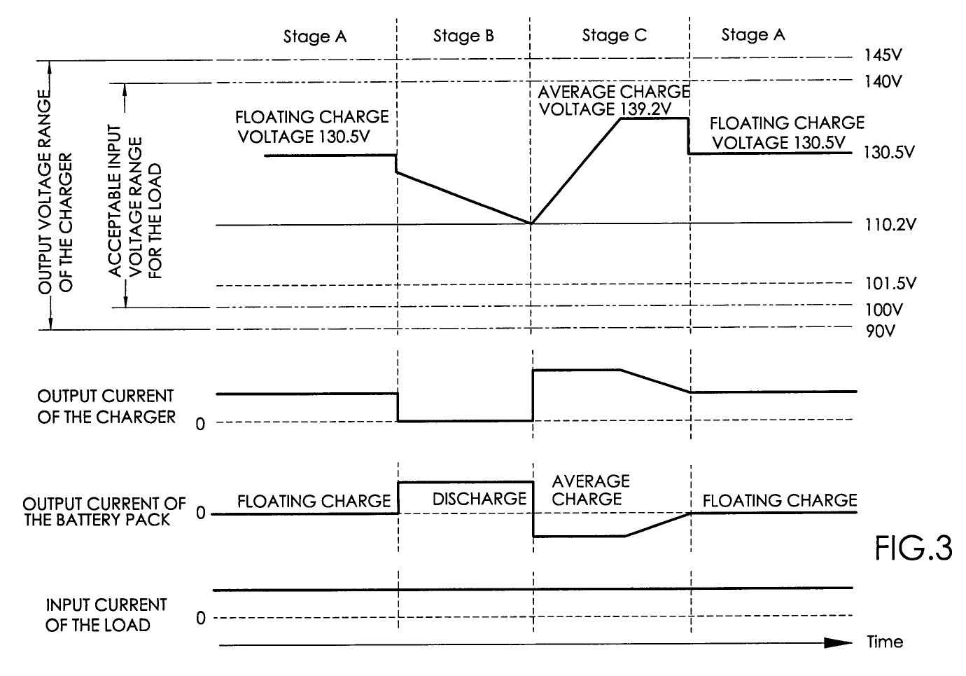

As an example, with reference to FIG. 3, an acceptable input voltage for the load (10) is in a range of 100-140V, the output voltage of the charger (30) is in range of 90-145V. The floating charge voltage of the battery pack (20) is 130.5V (2.25V×58 cells). The average charge voltage of the battery pack (20) is 139.2V (2.4V×58 cells). The minimum output voltage of the battery pack (20) is 101.5V (1.75V×58 cells). The discharge-stop voltage for the battery pack (20) is 110.2V.

When the external power line is normal as shown in stage A, the charger (30) can supply an output voltage to the load (10), meanwhile the battery pack (20) remains at the floating charge voltage 130.5V.

As shown in stage B, when the external power line is interrupted or the output voltage of the charger (30) is purposely decreased to 110.2V that is lower than the floating charge voltage of the battery pack (10), the charger (30) stops its power supply to the load (10) and the battery pack (20) starts to discharge and supplies voltage to the load (10). At the same time, scanning for a charger-resumption condition is also started.

The above mentioned charger resumption condition is to be determined by either one of the two criteria explained below:
(1) Discharging duration: a predetermined discharging duration of the battery pack (20) can be set by the battery user. When the discharging duration of the battery pack (20) has elapsed, the battery pack (20) stops its discharge and the charger (30) re-supplies its output voltage to the load (10).
(2) Battery characteristics:
(a) Total voltage of the battery pack (20) can be taken as a precondition. When the total voltage of the battery pack (20) during discharging is decreased to the discharge-stop voltage, for example 110.2V in the embodiment, the battery pack (20) stops its discharge and the output voltage of the charger (30) is immediately boosted to re-supply power to the load (10) and simultaneously to charge the battery pack (20) as shown in stage C.
(b) When abnormal voltage change is detected in any cell of the battery pack (20). This situation is also used as a condition that causes the charger (30) to re-supply power to the load (10).
(c) When the operating temperature of the battery pack (20) is increased to a predetermined level during the discharge. This situation is used as a condition that causes the charger (30) to re-supply power to the load (10).

As shown in the transition from stage B to stage C, because the discharge-stop voltage is set to be 110.2V, whenever the total voltage of the battery pack (20) drops below 110.2V, the output voltage of the charger (30) is immediately boosted to a level higher than the total voltage of the battery pack (20). Therefore, the charger (30) resumes the power supply to the load (10).

On the other hand, when the output voltage or the operating temperature of any battery cell in the battery pack (20) experiences abnormal variation, the charger (30) will re-supply power to the load (10).

Using the above method, the charger (30) is purposely ordered to decrease its output voltage having supplied to the load for a time, to cause the battery pack (20) to discharge and supply power to the load, but the output voltage of the charger (30) is still maintained above a minimum output voltage 110.2V. Because the minimum output voltage 110.2V is still within the acceptable input voltage range 100-140V of the load (10), even if the battery pack (20) fails, the charger (30) is able to continue with the power supply to the load (10), with no risk of operation interruption for the system equipment.

Besides the battery pack (20) being safely discharged, the method allows the battery pack (20) to remain in the discharging state for a prolonged period to facilitate the collection of battery characteristic data in order to produce a more accurate estimation of the battery capacity and remaining service life.

In actual implementation, the above mentioned method can be implemented in the battery recorder (40), such that the control command for decreasing voltage is issued to the charger (30) through the signal line connection. Alternatively, the method can be implemented in the charger (30) or in a control unit of the uninterrupted power supply (UPS), such that the charger (30) or the UPS is able to control the output voltage directly. In the above case, the charger (30) or the UPS needs the capability to collect the battery characteristic data on-line.

In the aspect of the control command, the control command can be in the form of an analog signal or a digital signal. For example, an analog control command with an adjusted voltage range (0-5V) to correspond to different output voltage potentials that the charger (30) should drop; otherwise, the control command in the digital form can be output through an input/output interface to determine the output voltage of the charger (30).

Alternatively, the digital control signals can also be implemented with communication protocols to control the output voltage of the charger (30) by software control for precision tuning of the output voltage of the charger (30).

From the foregoing, it is clear that power supply method allows the battery pack (20) to be placed in charge and discharge statuses even when the external power is normal to prevent unpredictable failure of the standby power unit. The method can also perform regular testing to determine whether the battery pack is able to be operated normally. The charge/discharge for the battery pack can be a periodic or non-periodic execution.

The foregoing description of the preferred embodiments of the present invention is intended to be illustrative.

1. A method of testing a battery pack coupled to a load, the load being further connected to a charger that couples to an external power line, wherein the method comprising the acts of:
measuring a total voltage of all battery cells in the battery pack;
purposely decreasing an output voltage of the charger to a level below the total voltage of the battery pack by a control command, but still within an acceptable range for the load;
starting discharge of the battery pack and supplying its output voltage to the load instead of from the charger;
determining whether a charger resumption condition is met, wherein if the charger resumption condition is met, the output voltage of the charger is raised to re-supply to the load and to charge the battery pack, wherein the discharge of the battery pack is accordingly stopped.

2. The method as claimed in claim 1, wherein the battery pack is further connected to a battery recorder for collecting and recording characteristic data of the battery pack during discharge and charge, the battery recorder executes the method and outputs the control command to the charger.

3. The method as claimed in claim 1, wherein the method is built in the charger.

4. The method as claimed in claim 1, wherein the charger is implemented with an uninterrupted power supply.

5. The method as claimed in claim 1, wherein a predetermined discharging duration is used as the charger resumption condition for the charger.

6. The method as claimed in claim 2, wherein the collected and recorded characteristic data of the battery pack are used as the charger resumption condition.

7. The method as claimed in claim 6, wherein the characteristic data refers to whether the total voltage of the battery pack is abnormal.

8. The method as claimed in claim 6, wherein the characteristic data refers to whether an output voltage of any one battery cell in the battery pack is abnormal.

9. The method as claimed in claim 6, wherein the characteristic data refers to an operating temperature of the battery pack.

10. The method as claimed in claim 2, wherein the control command is an analog signal.

11. The method as claimed in claim 2, wherein the control command is a digital signal.

12. The method as claimed in claim 11, wherein the digital signal is implemented with communication protocols by software control.
